(19) United States
(12) Patent Application Publication
(10) Pub. No.: US 2022/0415329 A1
(43) Pub. Date: Dec. 29, 2022

(54) SYSTEM FOR STORING VOICE RECORDING INFORMATION BASED ON BLOCKCHAIN

(71) Applicant: SOGANG UNIVERSITY RESEARCH & BUSINESS DEVELOPMENT FOUNDATION, Seoul (KR)

(72) Inventors: Soo Yong PARK, Seoul (KR); Myoung Wan KOO, Seoul (KR); In Geun KIM, Seoul (KR)

(21) Appl. No.: 17/776,988

(22) PCT Filed: Oct. 26, 2020
(86) PCT No.: PCT/KR2020/014651

§ 371 Date: Jun. 30, 2022

(30) Foreign Application Priority Data
Nov. 18, 2019 (KR) 10-2019-0148017

(51) Int. Cl. G10L 15/26; G06F 16/13

(52) U.S. Cl. CPC G10L 15/26; G06F 16/137

(57) ABSTRACT

Provided is a storage system for voice recording information based on a blockchain. The storage system for voice recording information comprises: a voice-to-text conversion device for converting a voice recording file into a text file using a preset voice-to-text conversion algorithm, and outputting the converted text file and information on the voice-to-text conversion algorithm; a blockchain network consisting of a plurality of participating nodes, and configured to generate blocks including the text file and information on the voice-to-text conversion algorithm output from the voice-to-text conversion device according to a preset consensus algorithm, and to store the generated blocks on the blockchain; and a data storage device for storing the original voice recording file, wherein the storage system reliably stores the text file for the voice recording file.

### TECHNICAL FIELD

The present invention relates to a storage system for voice-recording information, and more particularly, to a storage system for voice-recording information based on a blockchain in which a voice recording file related to a contract is converted into text, a voice-to-text conversion related information and the converted text are stored in the blockchain in the form of block, and the original voice recording file is stored in a separate data storage device, so that it is possible to reliably store voice-recording information to ensure integrity and security, as well as to conveniently check contents such as inquiry and audit.

### BACKGROUND ART

In general, a contract through telemarketing is made through a phone call, and information about the contract is included and stored in a voice recording file. The contract-related information included in these voice recording files is reproduced again during audits, inquiries, and disputes for the contracts to confirm the contents in future. Since these voice recording files are stored in the form of voice, it is difficult to check the contents, and it is not easy to search through keyword searches, etc.

On the other hand, blockchain technology is a data change prevention technology based on distributed computing technology where each data is stored in a chain-type distributed data storage environment created based on the peer-to-peer method, so that no one can arbitrarily modify it and anyone can view the results of the change. In a blockchain network, when a transaction is generated, the transaction is broadcasted to all nodes in the blockchain network, and the validity of this transaction is verified. When a preset number of validated transactions are gathered, a block is generated, and the generated block is broadcasted to all nodes in the blockchain network. After that, the block is verified through a consensus algorithm, and the verified block is linked with the last block of the blockchain and then recorded on the blockchain.

The biggest core of blockchain technology is decentralization. The nodes in the blockchain network have part or all of the blockchain. With this blockchain technology, there is no need to store all information in a centralized database, and arbitrary manipulation of data has become impossible. This is because, when one data is modified, the data of all nodes having information on the block in which the data is recorded must be replaced. Through this, blockchain technology can maintain data integrity. In addition, the data stored in the blockchain is encrypted by a hash algorithm, so security is guaranteed, and the information stored in the blockchain can be accessed by anyone, so transparency is guaranteed.

On the other hand, a distributed hash table (DHT) is a technology for distributing and managing hash tables. This DHT technology has a great advantage in that the load is distributed rather than concentrated, and even extremely large-scale nodes can be managed. This DHT can suppress the load on the network even in a pure P2P environment, and it is possible to quickly and accurately search for content on the network. Representative systems that use DHT include BitTorrent and eDonkey.

On the other hand, a hash tree is a kind of tree structure, also called a Merkle tree. Leaf-nodes of the hash tree indicates data such as a file, and each parent node becomes the hash value of each child node. Any hash function can be used, but usually a cryptographic hash function such as SHA-1, Tiger, or Whirlpool is used.

A user who wants to verify data can verify that the data is correct data by only knowing the hash value of the root node (called the root hash or master hash).

### SUMMARY OF INVENTION

An object of the present invention to solve the above problems is to provide a storage system for voice recording information which converts a voice recording file including information such as a contract using telemarketing into a text file and records it in a blockchain, thereby not only reliably storing it, but also conveniently checking the contents such as inquiry and audit using keywords, and as a result, increasing the efficiency of work.

In order to achieve the object, the present invention provides a storage system for voice recording information based on a blockchain, comprising: a voice-to-text conversion device for converting a voice recording file into a text file using a predetermined voice-to-text conversion algorithm, and outputting the converted text file and information on the voice-to-text conversion algorithm; and a blockchain network consisting of a plurality of participating nodes, and configured to generate blocks including the text file and information on the voice-to-text conversion algorithm output from the voice-to-text conversion device according to a preset consensus algorithm, and to store the generated blocks on the blockchain, wherein the storage system reliably stores the text file for the voice recording file.

In the storage system for voice recording information based on a blockchain according to the present invention, preferably the information on the voice-text conversion algorithm may include type information of the voice-text conversion algorithm and parameter information used for the voice-text conversion algorithm.

In the storage system for voice recording information based on a blockchain according to the present invention, preferably the storage system for voice recording information may further comprise a data storage device for storing the original voice recording file, and the original voice recording file for the text file may be stored in the data storage device.

In the storage system for voice recording information based on a blockchain according to the present invention, preferably the storage system for voice recording information may further comprise a application for file inquiry that is installed and executed in the terminals of users, and the file inquiry application, when a request for an arbitrary voice recording file occurs from the user, may search for and provide a text file for the corresponding voice recording file according to the request, or search for and provide the original voice recording file stored in the data storage device.

The storage system for voice recording information according to the present invention converts the voice recording file into a text file and records the text file in the blockchain in the form of a block, thereby ensuring the reliability of the text file for the voice recording file.

In addition, according to the storage system for voice recording information of the present invention, inquiry, audit, and dispute mediation work for contract information included in a voice recording file generated during a contract through telemarketing can be performed using a text information. As a result, the user can save time and money by using the system according to the present invention, unlike the conventional work performed using the voice information of the voice recording file.

In addition, according to the storage system for voice recording information of the present invention, by having an information storage system for storing contract-related text information on the blockchain, the trust of the voice-to-text conversion process is guaranteed, the stored text information is immune to forgery and falsification, and disputes between telemarketing companies and consumers can be minimized.

### BRIEF DESCRIPTION OF THE DRAWINGS

FIG. 1 is a block diagram showing the overall configuration of a storage system for voice recording information based on a blockchain according to a preferred embodiment of the present invention.

FIG. 2 is a block diagram illustrating an embodiment of the voice-to-text conversion apparatus 10 in a storage system for voice recording information based on a blockchain according to a preferred embodiment of the present invention.

FIG. 3 is a block diagram illustrating an embodiment of a blockchain processing module provided in each participating node of the blockchain network 30 in a storage system for voice recording information based on a blockchain according to a preferred embodiment of the present invention.

### DETAILED DESCRIPTION

Hereinafter, the structure and operation of a storage system for voice recording information based on a blockchain according to a preferred embodiment of the present invention will be described in detail with reference to the accompanying drawings.

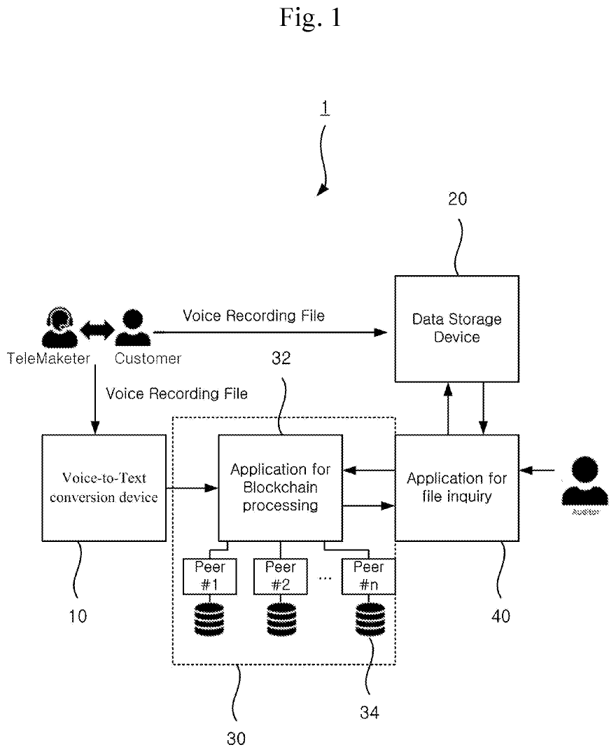

FIG. 1 is a block diagram showing the overall configuration of a storage system for voice recording information based on a blockchain according to a preferred embodiment of the present invention. Referring to FIG. 1, the storage system 1 of voice recording information based on the blockchain according to the present invention includes a voice-to-text conversion device 10 for a voice recording file; a data storage device 20 for storing the original voice recording file; a blockchain network 30 including a plurality of participating nodes (Peer #1, #2, #3, . . . , #n) having a blockchain 34; and an application 40 for file inquiry. When the voice recording file is generated, the voice recording information storage system 1 stores the original voice recording file in a data storage device, converts the voice recording file into a text file, generates a block containing the converted text file and conversion related parameter information, and stores the generated blocks on the blockchain, Each of the plurality of participating nodes (Peer #1, #2, #3, . . . , #n) of the blockchain network 30 has an application 32 for blockchain processing. The application 32 for blockchain processing is software installed and executed on each participating node, and generates blocks using transactions broadcasted in the blockchain network, and the generated blocks are recorded in the blockchain. On the other hand, the application for file inquiry 40 is software installed and executed in each participating node, and when a request for a specific voice recording file is generated from a user, the corresponding text file or the original voice recording file is provided.

Hereinafter, the above-described configurations will be described in more detail.

The data storage device 20 is a database device in which the original voice recording file is stored, and when a request for a specific voice recording file is generated from the application for file inquiry 40, the corresponding voice recording file is provided.

The voice-to-text conversion device 10 converts a voice recording file into a text file using a preset voice-to-text conversion algorithm, and transmits the converted text file and information on the voice-to-text conversion algorithm to the blockchain network. The information on the voice-text conversion algorithm includes a type information of the voice-text conversion algorithm and parameter information used in the voice-text conversion algorithm.

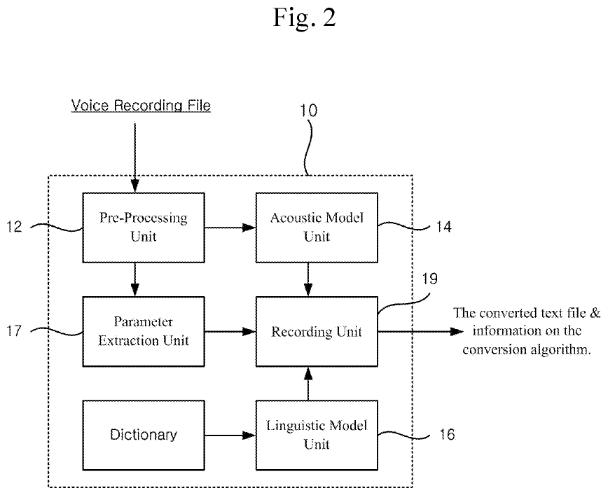

FIG. 2 is a block diagram illustrating an embodiment of the voice-to-text conversion apparatus 10 in a storage system for voice recording information based on a blockchain according to a preferred embodiment of the present invention. Referring to FIG. 2, the voice-text conversion device 10 includes a pre-processing unit 12, an acoustic model unit 14, and a linguistic model unit 16, a parameter extraction unit 17 and a recording unit 19 to convert a voice recording file, which is input information, into a text file, and output the converted text file and information on the conversion algorithm. The information on the conversion algorithm includes information on a type of the conversion algorithm and parameters used in the conversion algorithm.

The pre-processing unit 12, which extracts signal and frequency domain features from a voice signal like the auditory system for transformation and feature extraction, functions as the cochlea of the auditory system, and extracts periodicity and synchronization information from the voice signal.

The acoustic model unit 14 calculates a result value from the features extracted from the pre-processing unit, and serves to recognize phonemes, syllables, and words, which are elements necessary to construct a sentence, based on the characteristics obtained through the pre-processing of the voice signal by the pre-processing unit. In general, for this, phonetics, phonology, phonological arrangement theory, poetry theory, etc. are required, and various dictionary-based voice recognition algorithms are used, and the approach for each recognition algorithm is as follows. The DTW algorithm is an approach through dynamic programming, the HMM algorithm is an approach through probability estimation, the Knowledge Base algorithm is an approach through reasoning using artificial intelligence, and the Neural Network algorithm is an approach through pattern classification.

The linguistic model unit 16 reconstructs a sentence by reconstructing phonemes, syllables, and words that are the result of pattern recognition for language processing. For this purpose, syntax, semantics, and morphology are used. Rule-based models and statistics-based models are used to construct sentences. A syntactic model constructs a sentence by limiting the types of words that can come after each word. A statistical model recognizes a sentence by considering the probability of occurrence of the previous N words for each word.

The parameter extraction unit 17 extracts parameters used in the voice processing model unit and the language processing model unit from the features extracted from the pre-processing unit.

The recording unit 19 uses the parameter information extracted by the parameter extraction unit, the voice processing information output from the voice processing model unit, and sentences restored from the language processing model unit using the voice processing information, to create and record a text file, and output the text file and the parameter information. The parameter information indicates a conversion key having characteristics for each voice-text conversion algorithm. Accordingly, if there are only the type of the voice-to-text conversion algorithm and parameter information used therefor, the same voice recording file can be converted into the same text file and output.

The voice-to-text conversion apparatus having the above-described configuration converts a voice recording file input from the outside into a text file using a preset voice-to-text conversion algorithm, and outputs the converted text file and information on the voice-text conversion algorithm. The information on the conversion algorithm includes information on a type of the conversion algorithm and parameters used in the conversion algorithm.

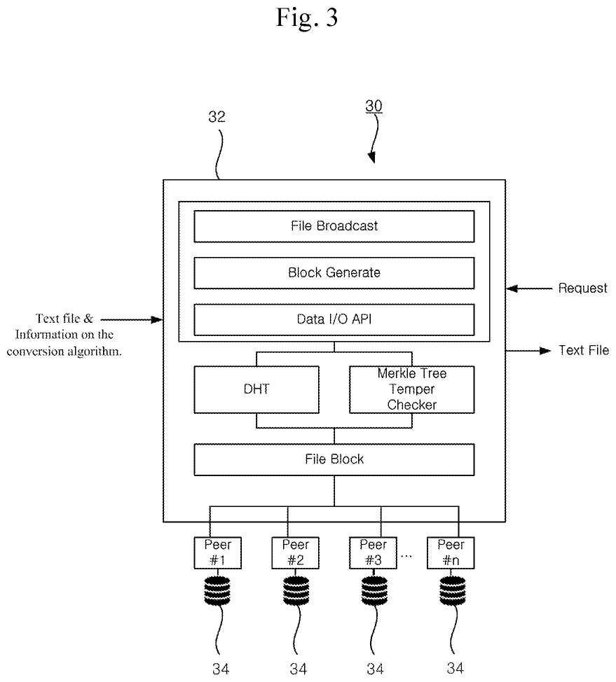

FIG. 3 is a block diagram illustrating an embodiment of a blockchain processing module provided in each participating node of the blockchain network 30 in a storage system for voice recording information based on a blockchain according to a preferred embodiment of the present invention. Referring to FIG. 3, the blockchain network 30 is configured to include a plurality of participating nodes (Peer #1, #2, #3, . . . , #n), and the blockchain processing application 32 provided in each participating node generates a transaction in which data is recorded, generates a block including the transaction according to a preset consensus algorithm, and stores the generated block in the blockchain of each participating node.

In the system according to the present invention, the application 32 for blockchain processing provided in any participating node generates a transaction including the corresponding data when text information and information on the conversion algorithm are input, and creates a file block including the transaction according to a preset consensus algorithm and stored it. The storage copy is stored in the blockchain of each peer node. Since the stored files are located in the leaf node of the Merkle Tree, by checking only the root node of the Merkle Tree, it is possible to check whether the files stored in the blockchain are forged or altered. This series of processes are managed by the Distributed Hash Table (DHT), where a unique ID assigned to each file and information about the original file are stored. Basically, the application for blockchain processing includes a File Broadcast function and a Block Generate function, and also includes a DATA I/O API function for transmitting a text file as an output according to a request from the application for file inquiry 40.

On the other hand, the application for file inquiry 40 is an application software installed on a user's terminal, etc., and is an application software directly used by the user. When a user requests a text file for an arbitrary voice recording file through the execution of the application for file inquiry, the application for file inquiry requests the necessary information to the blockchain or data storage device, and according to the request, a text file is provided from the blockchain or an original voice recording file is provided from the data storage device.

In the storage system of voice recording information according to the present invention, a participating node of a blockchain network receives a text file converted from a voice recording file and parameter information from a voice-text conversion device, and performs a transaction in which the text file and parameter information are recorded. It creates a block including the transaction according to a preset consensus algorithm, and records the block in the blockchain. As a result, in the system according to the present invention, a text file converted from a voice recording file can be reliably stored in the blockchain.

On the other hand, the storage system for voice recording information having the above-described configuration stores the voice recording file in the form of a text file, so that inquiry and inspection can be performed very conveniently. In addition, the storage system for voice recording information according to the present invention records and stores the text information obtained by converting the voice information generated during the telemarketing contract in the blockchain, thereby confirming whether this is text information from the original voice recording file. In addition, it is possible to guarantee the reliability of the text file itself without forgery or tampering.

Therefore, users can search and inquire text files for voice recording files stored in the blockchain of the blockchain network using textual search keywords. In addition, by enabling the system according to the present invention to obtain the original voice recording file for the corresponding text file from the data storage device, if necessary, it is possible to check again whether the text file matches the original.

In the above, the present invention has been described based on preferred embodiments thereof, but this is merely an example and does not limit the present invention, and those of ordinary skill in the art to which the present invention pertains will appreciate that various modifications and applications not exemplified above are possible without departing from the essential characteristics of the present invention. And, the differences related to these modifications and applications should be interpreted as being included in the scope of the present invention defined in the appended claims.

What is claimed is :

1. A storage system for voice recording information based on a blockchain, comprising
a voice-to-text conversion device for converting a voice recording file into a text file using a preset voice-to-text conversion algorithm, and outputting the converted text file and information on the voice-to-text conversion algorithm; and
a blockchain network consisting of a plurality of participating nodes, which the nodes are configured to generate blocks including the text file and information on the voice-to-text conversion algorithm output from the voice-to-text conversion device according to a preset consensus algorithm, and to store the generated blocks on the blockchain,
wherein the storage system reliably stores the text file for the voice recording file.

2. The storage system for voice recording information based on a blockchain according to claim 1, wherein the information on the voice-text conversion algorithm includes the type of the voice-text conversion algorithm and parameter information used for the voice-text conversion algorithm.

3. The storage system for voice recording information based on a blockchain according to claim 1, wherein the storage system for voice recording information further comprises a data storage device for storing the original voice recording file, and the original voice recording file for the text file is stored in the data storage device.

4. The storage system for voice recording information based on a blockchain according to claim 1, wherein the storage system for voice recording information further comprises an application for file inquiry that is installed and executed in the terminals of users, and the application for file inquiry, when a request for an arbitrary voice recording file occurs from the user, searches for and provides a text file for the corresponding voice recording file according to the request, or searches for and provides the original voice recording file stored in a data storage device.

5. The storage system for voice recording information based on a blockchain according to claim 1, wherein the voice recording file is a voice recording file generated during a telemarketing contract including contract information.
